(19) United States
(12) Patent Application Publication
(10) Pub. No.: US 2004/0052684 A1
(43) Pub. Date: Mar. 18, 2004

(54) Diagnostic kit and method of using same

(76) Inventors: Jerome L. Sinsky, Escondido, CA (US); Christopher J. Gyben, Escondido, CA (US)

Correspondence Address: JERRY RICHARD POTTS, 3248 VIA RIBERA, ESCONDIDO, CA, 92029, US

(21) Appl. No.: 10/303,535

(22) Filed: Nov. 23, 2002

Related U.S. Application Data
(63) Continuation-in-part of application No. 10/244,133, filed on Sep. 14, 2002.

(51) Int. Cl. G01N 31/22

(52) U.S. Cl. 422/61; 436/165

(57) ABSTRACT

A diagnostic kit for use in performing clinical tests on a fluid specimen includes slides with attached slipcovers, tests solutions for facilitating microscopic analysis procedures, a differential diagnosis chart to provide an immediate visual indication of any microscopy including syndrome identifiers and diagnostic criteria, specimen obtaining sterile applicators, and test result cards. Each individual slide is a transparent plate covered by a panel overlay that is sufficiently thick for defining a plurality of test site wells. Indicia indicators disposed on the panel overlay adjacent to each individual test site well, provides technical assistance in the performance of diagnostic analysis on a fluid specimen deposited within each test site well. Each test site well is sufficiently deep to confine the fluid specimen as well as a measured drop quantity of one or more of the test solutions. An individual one of the test site wells is a pH testing well that has disposed therein a strip of pH testing material, wherein the pH testing material produces a color indicative of fluid pH upon contact with a fluid specimen. The indica indicator disposed adjacent to the pH testing well is a pH chart to provide a comparison color chart for immediate identification of the fluid specimen pH level. Another one of the test site wells defines a light passing window where the indicia disposed adjacent to the window is an indicator of which individual ones of the test solutions is to be deposited into the well for facilitating microscopic analysis of a fluid specimen deposited within the well.

### RELATED PATENT APPLICATIONS

This application is a continuation-in-part of U.S. patent application Ser. No. 10/244,133 Entitled “Diagnostic Device and Method of Using Same”, filed on Sep. 14, 2002.

### BACKGROUND OF THE INVENTION

The present invention relates generally to clinical diagnostic testing devices and, more particularly, to clinical diagnostic testing kits as utilized by physicians in their offices.

It is recognized that in the case of many pathological conditions, early identification and treatment can substantially reduce subsequent patient suffering. In this regard, testing of female vaginal samples has become recognized as important to the health of a patient.

The problem of vaginitis is one of the most common complaints bringing patients to physician's offices or clinics. The diagnosis is made after examination of vaginal fluid and testing of fluid pH, and a microscopic examination of the fluid.

In order for the test be competently performed, the pH of the fluid should be measured. Changes in pH can be visually observed. For example, a vaginal pH sampler, having pH paper mounted at the end of a plastic stick can be used to sample the vagina directly, While the stick has some utility, it presents a waste management problem after use, as the clinician attempts to dispose of it. In addition, the stick is limited in use solely for pH detection.

“Wet mount” tests follow as microscopic examination follows pH determination. The fluid is treated with potassium hydroxide (KOH) and the fluid/reagent mix is examined under the microscope for the presence of yeast cells or hyphae.

A fluid sample is also treated with saline solution and microscopically examined for the possible presence of clue cells (epithelial cells obscured by an overgrowth of bacterial cells), white blood cells and, among other things, motile organisms, spores and trichomonads.

The combination of pH determination plus the KOH and saline microscopic examination is the most widely accepted and clinically used method in determining the cause of vaginitis.

At the present time, there is a lack of inexpensive, convenient techniques for supporting performance of the diagnostic steps. The use of the pH stick, and the need to dispose of after use has been mentioned. Performance of the wet mount tests complicates the matter since handling of fluid and reagents of samples for microscopic examination can be cumbersome. It can involve, for example, tearing off a piece of pH paper from a roll and wetting it with a vaginal sample. It may also involve the use of a separate container or vial, for transporting the sample to a laboratory either in an office or at a clinic for microscopic examination. Drops of the sample are then placed on two sites of a microscope slide. In some cases, a wax line is drawn down the center of a diagnostic device in an attempt to keep the saline treated fluid separate from the KOH treated fluid during the microscopic examination. At other times, two separate microscope slides are used to avoid mixing the two solutions. After microscopic examination, of course, the waste management problem is presented once again as disposal of wet slides, pH paper, pH sticks and transport containers or vials becomes necessary.

The above-mentioned conventional techniques are awkward to perform, time consuming and can present a problem in disposal of wet materials, possibly carrying pathogens. Accordingly, there has been a need for a diagnostic technique that provides a quick, relatively inexpensive and reliable way to perform the three tests on vaginal fluid samples in a more convenient, economical fashion. Desirably, such a technique would help ameliorate the waste disposal and handling problems. Many clinicians, therefore, skip one or more of these diagnostic steps and try to rely on guesswork to make a diagnosis here and this has been shown in studies to result in diagnostic and treatment errors.

### DISCLOSURE OF THE INVENTION

In a preferred embodiment, the invention provides a diagnostic device and kit for use in performing clinical tests on a specimen fluid. The diagnostic kit includes light transmitting slides with or without attached slipcovers, tests solutions for facilitating microscopic analysis procedures, a differential diagnosis chart to provide an immediate visual indication of any microscopy including syndrome identifiers and diagnostic criteria, specimen obtaining sterile applicators, and test result cards. Each individual slide is a transparent plate covered by a panel overlay, which is sufficiently thick for defining a plurality of test site wells. Indicia indicators disposed on the panel overlay adjacent to each individual test site well, provides technical assistance in the performance of diagnostic analysis on fluid specimens deposited within the test site wells. Each test site well is sufficiently deep to confine the fluid specimen as well as a measured drop quantity of one or more of the test solutions. An individual one of the test site wells is a pH testing well that has disposed therein a strip of pH testing material, wherein the pH testing material produces a color indicative of fluid pH upon contact with a fluid specimen. The indica indicator disposed adjacent to the pH testing well is a pH chart to provide a comparison color chart for immediate identification of the fluid specimen pH level. Another one of the test site wells defines a light-passing window wherein the indicia disposed adjacent to the window is a procedure indicator for facilitating microscopic analysis of a fluid specimen deposited within the well.

A diagnostic device and kit embodying the invention is mechanically simple, and is easy and convenient to use. It enables the grouping of components in a relatively small, easily reached countertop area and helps improve safe waste management by reducing the number of contaminated implements requiring disposal.

Other aspects and advantages of the present invention will become apparent from the following detailed description, taken in conjunction with the accompanying drawings, illustrating by way of example the principles of the invention.

### BRIEF DESCRIPTION OF DRAWINGS

FIG. 1 is an isometric view of a preferred embodiment of a diagnostic device that is constructed according to the present invention;

FIG. 2 is a plan view of the diagnostic device shown in FIG. 1;

FIG. 3 is an exploded pictorial view of another preferred embodiment of a diagnostic kit that is constructed in accordance to the present invention;

FIG. 4 is an isometric view of a kit container of FIG. 3;

FIG. 5 is an isometric view of another preferred embodiment of a diagnostic kit that is constructed in accordance to the present invention; and

FIG. 6 is an isometric view of still yet another preferred embodiment of a diagnostic kit that is constructed in accordance to the present invention.

### BEST MODE FOR CARRYING OUT THE INVENTION

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

In the following detailed description and in the several figures of the drawings, like elements are sometimes identified with like reference numerals.

As shown in the drawings for purposes of illustration, the invention is embodied in a novel diagnostic kit and device for enabling effective and efficient real time diagnosis of a medical condition. The diagnosis comprises both gross examination and microscopic examination of a bodily fluid by means of a device that is simple and convenient to use and, as one piece, is relatively safer from a waste management viewpoint.

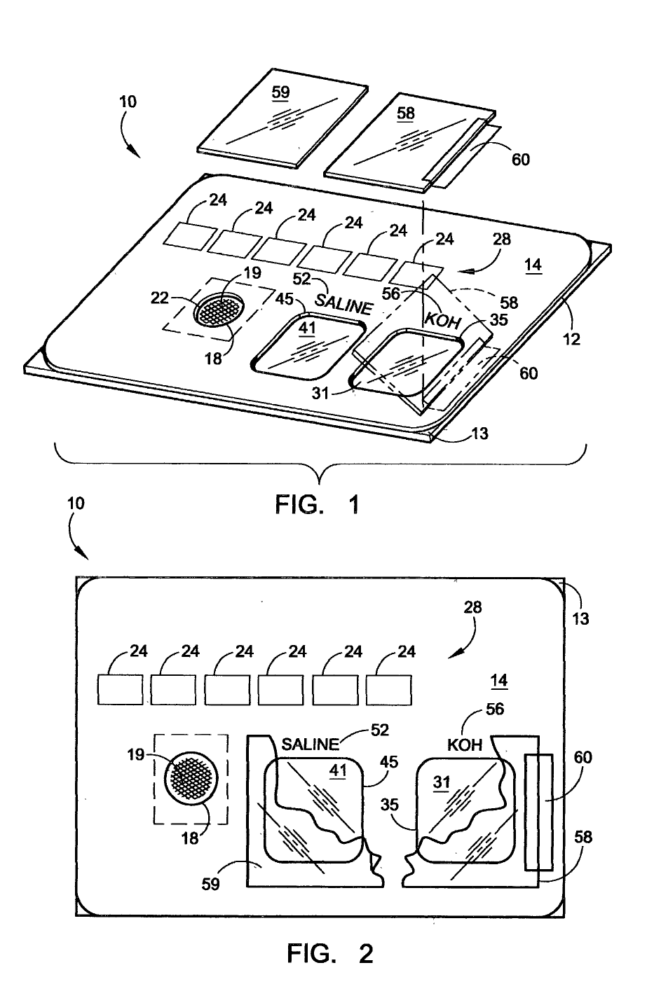

Referring now to the drawings, and in particular to FIGS. 1 and 2, there is shown a diagnostic device 10 that is constructed according to the present invention. The diagnostic device 10 is a disposable device that enables a clinician to perform a series of tests on vaginal fluid samples in a more convenient, economical fashion as will be explained hereinafter in greater detail. Moreover, since the diagnostic device 10 is disposable it helps ameliorate waste disposal and handling problems associated with other testing devices.

Considering now the diagnostic device 10 in greater detail with reference to FIGS. 1-2, the diagnostic device 10 is formed from a generally rectangular, light transmitting blank, or plate 12. The plate 12 is generally about 2 inches in height and about 3 inches in width and thus, is very easily handled.

As best seen in FIG. 1, the plate 12 is substantially covered by a stiff paper or cardboard panel 14 that adheres to an upper surface 13 of the plate 12. In the upper half of the panel 14 there is disposed a color gradient chart, generally referred to by the reference numeral 28. The color gradient chart 28 provides a series of color indicators 24, where colors across the gradient are indicative of pH indicators of about pH 3.0 to about pH 5.5. This color gradient arrangement, allows a clinician to conduct a simple visual matching, without the need of resorting to any other charts or tools for determining the pH level of a sampled fluid as will be explained hereinafter in greater detail.

A pair of adjacent cutouts or windows 31 and 41 respectively, is disposed in the panel 14 in its lower right quadrant. Another cutout or opening 18 is also disposed in a lower left quadrant of the panel 14. A strip of pH testing material, here in the form of pH indicator paper 19, is fixed between the plate 12 and the panel 14 to fill substantially the opening 18. The panel 14 is sufficiently thick to form a step or a wall 22 circumscribing the opening 18. The wall 22 in cooperation with plate 14 defines a test site well that helps confine any fluid placed in the opening 18. As in the case of the opening 18, steps or walls 35 and 45 circumscribe the windows 31 and 41, respectively, that serve to retain fluids within the respective test site areas therein defined. In this manner, after examination is completed, effective elimination of possibly contaminated fluid can be accomplished.

To further help facilitate retaining any vaginal fluids deposited in the window area wells 31 and 41, the diagnostic device 10 includes a pair of cover slips, such as the cover slips 58 and 59 respectively. The cover slips are adapted to be attached to the top surface of the panel 14 by a flexible adhesive hinge, such as the hinge 60. In this manner, after a vaginal fluid sample has been deposited into either window area, the slip cover can be attached to the plate 14 as indicated allowing the cover to close the fluid receiving area of the window. In the preferred embodiment of the present invention, the slip covers 58 and 59 are separated from the panel 14. It will be understood however, by those skilled in the art, that the slip covers could also be initially attached by their respective hinges, such as the hinge 60, rather than be separated.

Considering now the method of using the diagnostic device 10 for testing vaginal fluids, the clinician in testing for fluid pH, first places a drop of fluid (not shown) onto the pH indicator paper 19 and observes any color change in the paper. The resultant color is indicative of the fluid pH and this can be determined readily by reference to the colored chart 28. Thus, by simple visual matching, and without need to resort to other tools or separate reference color charts, the clinician can determine the pH of the fluid.

As set forth above, microscopic analysis is appropriate, along with a determination of fluid pH. Such analysis is facilitated by use of the windows 31 and 41 formed in the label 14. As in the case of the opening 18, steps or walls 35 and 45 circumscribe the windows, respectively, that serve to retain fluids within the respective areas therein defined.

In use of the diagnostic device 10, microscopic examination of both the KOH and saline preparations are preferred. In this regard, upon determination of the type of microscopic examination desired, the clinician chooses the KOH window 31 and then after examination the saline window 41. As best seen in FIG. 2, indicia 52, located adjacent the window 41, displays the word “Saline” to prompt the clinician to add this solution to fluid previously placed on the window 41. In a similar manner, indicia 56, located adjacent the window 31, prompts the clinician to add potassium hydroxide (KOH) to the fluid on the window 31. It should be understood by those skilled in the art that although the preferred embodiment of the present invention describes the test solutions as a saline solution and a potassium hydroxide solution, the diagnostic device 10 can be utilized to conduct gross and microscopic testing that may utilize other types of test solutions. There is therefore no intention to limiting the test solution described in the kit to only saline and potasium hydroxide.

After the suitable reagents have been added to the fluids in the windows 31 and 41, cover slips 58 and 59, respectively, cover the windows for the microscopic examination. One skilled in the art will recognize at this step of the diagnostic process that subsequent disposal of the diagnostic device 10 and its contents is simplified by having all the reactants compartmentalized on the single plate 10.

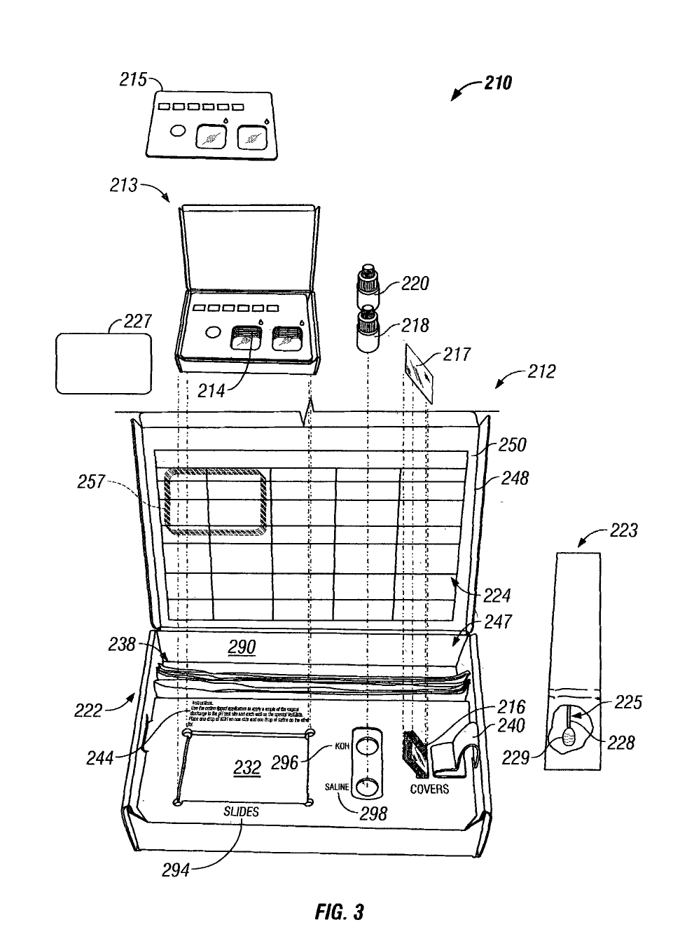

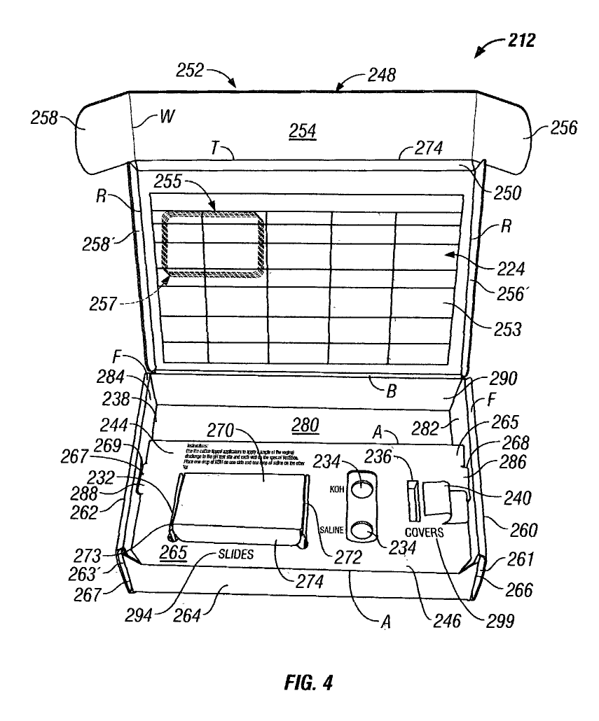

Referring now to the drawings, and in particular to FIGS. 3 and 4, there is shown a diagnostic kit 210 that is constructed according to the present invention. The diagnostic kit 210 is disposable when it has been spent and accordingly the kit enables a clinician to perform a series of tests on fluid samples in a more convenient, economical fashion as will be explained hereinafter in greater detail. Moreover, since the diagnostic kit 210 is disposable it helps ameliorate waste disposal and handling problems associated with other testing kits and devices.

Considering now the diagnostic kit 210 in greater detail with reference to FIGS. 3-4, the diagnostic kit 210 is a self contained and disposable when spent and includes the necessary elements to enable a physican to perform an in office diagnostic analysis in a quick, relatively inexpensive and reliable manner. In this regard, there is no necessity of sending specimen samples outside of the office and thus, testing and diagnostic analysis can be immediately performed while a patient is conveniently waiting in the office for test results.

The diagnostic kit 210 generally includes a primary storage box or container 212 that is adapted to secure the kit's operative elements in a sufficiently protected manner to allow a physican to carry the operative elements of the kit from examination room to examination room. The container 212 is formed from a single sheet of stiff cardboard that has been cut and folded to form a sturdy container that holds all the operative elements of the kit 210. In this regard, the container 212 includes a base or floor 280 that is folded at its right side to form a right side panel 260 and folded at its left side to form a left side panel 262.

The right side panel 260 is further folded along a fold line F to form a right inside wall 282 and a right tab-receiving pocket 261. The inside wall 282 includes a tab (not shown) that is secured in a right side base slot (not shown) to hold the right side panel 260 and its integrally connected right inside wall 282 in an upright position.

In a similar manner the left side panel 262 is folded along another fold line F to form a left inside wall 284 and a left tab-receiving pocket 263. The inside wall 284 include a tab (not shown) that is secured in a left side base slot (not shown) to hold the left side panel 262 and its integrally connected left inside wall 284 in an upright position.

The base 280 is further folded upward at its front side to form a front wall 264 that is further folded along a fold line A to form a platform or well panel 265. The well panel 265 is folded downward along another fold line A to form a supporting member (not shown) with a set of tabs (not shown) that are secured in a pair of floor slots (not shown) to help establish a well space below the well panel 265. The well panel 265 is cut at its right side to form a right side well panel tab 286 and cut at its left side to form a left side well panel tab 288. The right tab 286 is received within a right side wall slot 268 that is formed in the right inside wall 282. In a similar manner, the left tab 288 is received with a left sidewall slot 269 that is formed in the left inside wall 284. In this manner the right and left sides of the well panel 265 are further supported to help establish the well space below the well panel 265.

As best seen in FIG. 4, the front wall 264 is cut to form a right front wall tab 266 and a left front wall tab 267. The tabs 266 and 267 are received within the right tab-receiving pocket 261 and the left tab-receiving pocket 263 to help secure the front wall 264 in an upright position.

The base 280 is further folded upward at its backside to form a back wall 290, which includes and integrally attached lid 248. The lid 248 is attached along a fold line B that permits the lid to pivot downward to help close a main compartment area 247 within the container 212.

Considering now the lid 248 in greater detail with reference to FIG. 4, the lid 248 is folded along a fold line R at its right side to form a right side closure panel 256′ and folded along another fold line R at its left side to form a left side closure panel 258′. The right side closure panel 256′ and the left side closure panel are received within the rain compartment area 247 and press outwardly against the right side wall 282 and the left inside wall 284 to help hold the lid 248 in a closed position.

The lid 248 is further folded along a fold line T to form a closure panel 254. The base 280 is cut about the closure panel 254 to form a right side closure tab 256 and a left side closure tab 258. The tabs 256 and 258 are folded downward along respective fold lines W to permit the tabs 256 and 258 to be received within the right tab receiving pocket 261 and the left tab-receiving pocket 263 when the lid 248 is pivoted downward along the fold line B disposed at the top of the back wall 290. In this regard, the tabs 256 and 258 are received within the tab receiving pockets 261 and 263 when the closure panel 254 is pivoted downward along fold line T. In this manner the lid 248 is releasably secured to tightly close and seal off the main compartment area 247.

Considering now the main compartment area 247 in greater detail with reference to FIGS. 3-4, the main compartment area includes an back compartment area or a sterile applicator package well 238, that has a sufficient volume to contain a plurality 222 of sterile applicator packages, such as an applicator package 223. Each applicator package, such as the applicator package 223 has disposed therein, as best seen in FIG. 3, a sterile applicator 225 that includes an elongated stick 228 having a cotton ball or swap 229 disposed on its distal end. The applicator package well 238 is bounded on its backside by the back wall 290, and bounded on its right and left side by the right inside wall 282 and the left inside wall 284 respectively. The front side of the applicator package well 238 is bounded by the back supporting wall (not shown) of the well panel 265.

Considering now the well panel 265 in greater detail with reference to FIGS. 3-4, the well panel 265 has a plurality of cutouts that form a plurality of diagnostic tool wells. In this regard, there is a primary diagnostic tool well 232 for receiving therein a box 213 that contains a plurality 214 of diagnostic tool devices or slides, such as a diagnostic device 215. The diagnostic device 215 will be described hereinafter in greater detail.

In order to help facilitating instructing a physician or clinician in using the kit 210, instruction indicia 244 is provided on the well panel 265 immediately above the primary diagnostic tool well 232. The well panel 265 also includes component identification indicia to help a user identify the various operative component disposed within the kit 210. This includes primary diagnostic device indicia 294, test solution identification indica 296 and 298 respectively, note indicia 246, and cover slip indicia 299. The exact indication of the component identification indica including the instruction indicia 244 will be described hereinafter in greater detail.

Considering the well panel 265 in still greater detail with reference to FIGS. 3-4, the well panel 256 further includes a plurality of test solution wells 234 that are disposed adjacent to the test solution identification indicia 296 and 298 respectively. In this regard, a user can immediately identify the correct test solution to be utilized with the diagnostic procedures made possible by use of the kit 210. In the preferred embodiment of the present invention, the kit 210 is a vaginal test kit that includes a bottle of saline solution 218 and a bottle of potassium hydroxide (KOH) for performing wet mount testing of vaginal fluid specimens obtained from a patient.

The well panel 265 further includes a cover slip well 236 which is disposed adjacent to the cover slip indicia 299. The cover slip well 236 is dimensioned for holding therein a box (not shown) of cover slips or a plurality 216 of loose cover slips, such as a cover slip 217. To help secure the cover slips 299 within the cover slip well 236, a retainer slip 240 is attached to the well panel 265. The retainer slip 240 is formed of a stiff piece of paper that is folded in such a manner as to provide a lid that extends over the cover slip well 236.

Considering now the lid 248 in greater detail with reference to FIG. 34, the lid 248 includes an inside surface area 250 and an outside surface area 252. The outside surface area 252 carries kit identification indicia (not shown) that identifies the type of diagnostic procedures or tests that can be performed with the kit, such as a vaginal test kit. The inside surface area 252 has attached thereto a stiff piece of cardboard 253 which is affixed at its bottom to the inside surface area to form a pocket area indicated generally at 255. A hook and pile arrangement (not shown) permits the top of the cardboard 253 to be releasably secured to the inside surface area 252. In this manner, an inside pocket 255 formed on the backside of the cardboard 253 can hold a plurality 257 of test result cards, such as an individual test result card 227 for easy retrieval when needed. The front side of the cardboard panel 253 has printed thereon a differential diagnosis chart 224. The chart 224 provides the physican or clinician with quick reference to a differential diagnostic tool of diagnostic criteria, syndrome indications and microscopy indications that can be referred to as a specimen sample (not shown) is being examined.

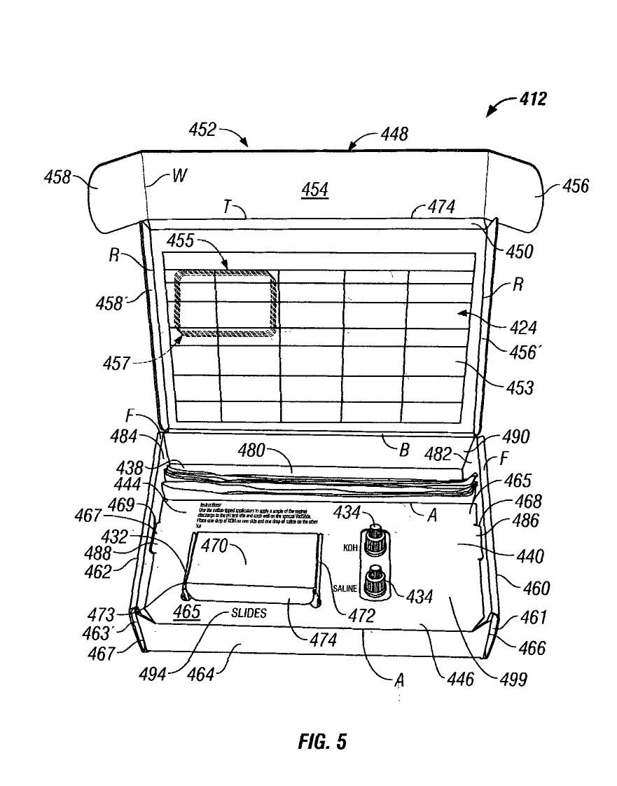

Referring now to the drawings and more particularly to FIG. 5 thereof, there is illustrated another diagnostic test kit 412, which is constructed in accordance to the present invention. In this preferred embodiment, the invention provides a diagnostic device and kit for use in performing clinical tests on a specimen fluid. The diagnostic kit 410 includes a box 413 for holding a light transmitting diagnostic device 10 (as best seen in FIGS. 1-2), tests solutions 434 for facilitating microscopic analysis procedures, a differential diagnosis chart 424 to provide an immediate visual indication of any microscopy including syndrome identifiers and diagnostic criteria, specimen obtaining sterile applicators 422, and test result cards 427.

The diagnostic device 10 is a transparent plate 12 covered by a stiff panel overlay 14, which is sufficiently thick for defining a plurality of test site well locations 18, 31 and 41 respectively. Indicia indicators 28, 52, and 56 respectively disposed on the panel overlay 14 adjacent to each individual test site well, provide technical assistance in the performance of diagnostic analysis on fluid specimens deposited within the test site well location.

The panel 12 is a thick piece of transparent material that readily passes light for microscopic examination purposes. In this regard, the panel 12 is sufficiently thick so that individual panel wells are provided within the panel 12 at each of the test site well locations 18, 31 and 41 respectively. The depth of each well location is determined by the depth of the associated panel well and the thickness of the panel overlay 14. As the panel wells and the test site wells are disposed in the same relative area on the diagnostic device 10, for simplicity in understanding the present invention, they are identified individually as well as in combination with one another as test site wells 18, 31, and 41 respectively. Each test site well, such as test site well 31 is sufficiently deep to confine the fluid specimen as well as a measured drop quantity of one or more of the test solutions.

As best seen in FIGS. 1-2, an individual one of the test site wells, such as test site well 18 is a pH testing well that has disposed therein a strip of pH testing material 19, wherein the pH testing material produces a color indicative of fluid pH upon contact with a fluid specimen. The indica indicator 28 disposed adjacent to the pH testing well is a pH chart to provide a comparison color chart for immediate identification of the fluid specimen pH level.

Other ones of the test site wells, such as the test site wells 31, 41 define light-passing windows wherein the indicia indicated generally at 52 and 56 disposed adjacent to windows 41 and 31 respectively are procedure indicators for facilitating microscopic analysis of a fluid specimen deposited within the associated well locations.

Considering now the container 412 in greater detail with reference to FIG. 5, the container 412 includes a right side panel 460, a left side panel 462, and a front panel 464 that cooperate to define the primary storage area 447. A right side wing-receiving pocket 461 is formed between the right side panel 460 and a fold down well panel 465 that is integrally connected at its front edge to the front panel 464. In a similar manner a left side wing-receiving pocket 463 is formed between the left side panel 462 and the fold down well panel 465.

To facilitate securing the fold down well panel 465 in a fixed position, the fold down well panel 465 includes a right well panel tab 466 and a left well panel tab 467. The panel tabs 465 and 466 are adapted to be received within tab receiving slots 468 and 469 respectively.

Considering now the lid 448 in greater detail with reference to FIG. 5, the lid 448 includes an outside surface area 452 which carries kit identification indicia (not shown) that identifies the type of diagnostic procedures that can be performed with the kit, such as a vaginal test kit. The lid 448 has integrally attached thereto a set of foldable panels that include a closure panel 454, a right side wing panel 456 and a left side wing panel 458. The panels 454, 456, and 458 are adapted to be received within the primary storage are 447 to secure the lid 448 in its closed position. More particularly, panels 456 and 458 are adapted to be received within the wing receiving pockets 461 and 463 respectively.

Considering the diagnostic device box 413 in greater detail with reference to FIG. 5, the diagnostic device box 413 is dimensioned to hold therein a plurality of the light-transmitting test slides, such as the test slides 215, and includes a lid indicated generally at 470, a right wing 472, a left wing 473, and a front flap 474. The right wing 472, the left wing 473 and the front flap 474 each fold downwardly from the lid 470 to be received within the slide box well space 432. In this manner, the box 413 is secured within the well space 432 but the lid 470 may be opened to allow easy access to the light transmitting slides stored within the box 413 providing not only ease of access but also helps to secure the light transmitting slides within the box 413.

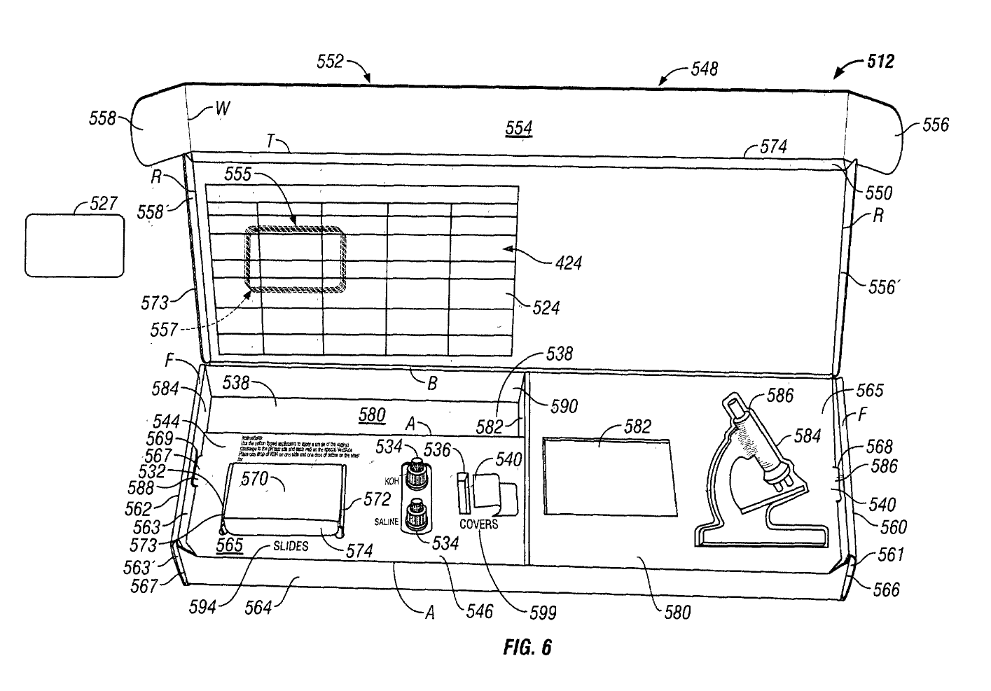

Referring now to the drawings and more particularly to FIG. 6, thereof there is illustrated still yet another diagnostic test kit 510, which is constructed in accordance to the present invention.

The diagnostic kit 510 generally includes a primary storage box or container 512 having a primary storage area 575 and a secondary or microscope storage area 580. In this regard, the container 512 is a doublewide storage container that is able to hold all the operative elements of the kit. The preferred embodiment of this invention is similar to test kit 210 holding like operative elements (not shown for simplicity purposes) but which includes the doublewide box 512 having the main compartment 575 and a side compartment 580.

Considering now the storage box 512 in greater detail with reference to FIG. 6, the side compartment 580 includes two wells, a test form well 582 and a microscope receiving well 584 which is dimensioned for receiving therein a microscope 586. A lid 548 that is adapted to pivot about one of its edges for closing the primary storage area 575 as well as the microscope storage area compartment 580.

The container 512 includes a plurality of diagnostic device or tool wells (or pockets) that includes 1) a slide box well 532 for securing a slide box 513 holding a plurality light-transmitting test slides (not shown) which individual light-transmitting slides are substantially identical to test slide 215; 2) a plurality of test kit solution wells, such as wells 534 for securing test kit solution containers (not shown), which containers are substantially identical to containers 218 and 220 respectively; 3) a cover slip well 536 and slipcover retainer 540 for securing a plurality of individual cover slips (not shown), which cover slips are substantially identical to cover slip 217; 4) a sterile applicator package well 538 for holding a plurality of sterile applicator packages (not shown), which individual packages are substantially identical to sterile applicator package and 5) a test result card pocket 526 for holding a plurality of individual 3×5 inch test result cards, such as a test result card 527. The test result card pocket 526 is formed on the backside of a stiff piece of cardboard attached to an inside surface area 550 of the container top 548. A differential diagnosis chart 524 is affixed to the outside face of cardboard to provide the physican with quick reference to a differential diagnosis tool of diagnostic criteria, syndrome indications and microscopy indications that can be referred to as a test sample (not shown) is being examined.

Considering now the container 512 in greater detail with reference to FIG. 6, the container 512 includes a right side panel 560, a left side panel 562, and a front panel 564 that cooperate to define the primary storage area 575 and the secondary storage area 580. A right side wing-receiving pocket 561 is formed between the right side panel 560 and a fold down well panel 565 that is integrally connected at its front edge to the front panel 564. In a similar manner a left side wing-receiving pocket 563 is formed between the left side panel 562 and the fold down well panel 565.

In the preferred embodiment of the present invention, the side compartment 580 is shown extending t the right side of the main compartment 575. However, those skilled in the art will understand that the side compartment 580 could be located in any other orientation relative to the primary compartment. That is, the secondary compartment can be located to left, in front of, or behind of the primary compartment through simple modifications to the overall container structure.

To facilitate securing the fold down well panel 565 in a fixed position, the fold down well panel 565 includes a right well panel tab 566 and a left well panel tab 567. The panel tabs 565 and 566 are adapted to be received within tab receiving slots 568 and 569 respectively.

Considering now the lid 548 in greater detail with reference to FIG. 6, the lid 548 includes an outside surface area 552 which carries kit identification indicia (not shown) that identifies the type of diagnostic procedures that can be performed with the kit, such as a vaginal test kit. The lid 548 has integrally attached thereto a set of foldable panels that include a closure panel 554, a right side wing panel 556 and a left side wing panel 558. The panels 554, 556, and 558 are adapted to secure the lid 548 in a closed position. More particularly, panels 556 and 558 are adapted to be received within the wing receiving pockets 561 and 563 respectively.

Considering the diagnostic device box 513 in greater detail with reference to FIGS. 3-4, the diagnostic device box 213 is dimensioned to hold therein a plurality of the light-transmitting test slides, such as the test slide 215. The diagnostic device box 513 includes a lid indicated generally at 570, a right wing 572, a left wing 573, and a front flap 574 that each fold downwardly to be received within a slide box well space 532. In this manner, the box 513 is secured within the well space 532 but the lid 570 may be opened to allow easy access to the light transmitting slides stored within the box 513. In short then, the lid 570 can be opened and closed for helping to access and secure the light transmitting slides.

It will be evident that there are additional embodiments and applications that are not disclosed in the detailed description but which clearly fall within the scope of the present invention. The specification is, therefore, intended not to be limiting, and the scope of the invention is to be limited only by the following claims.

We claim:

1. A diagnostic kit for use in performing clinical tests on a specimen fluid, comprising:
a storage container for holding a plurality of disposable diagnostic devices, each individual one of said plurality of disposable diagnostic devices including:
a plate, said plate being sufficiently thin to permit ambient light to pass therethrough;
a panel adhered to and substantially covering said plate and having at least one opening disposed therein for defining a specimen test site and for exposing a portion of said plate;
said panel being sufficiently thick to form a fluid receiving well at said test site; and
wherein said well has a sufficient volume to confine the specimen fluid deposited therein for testing purposes.

2. The diagnostic kit according to claim 1, wherein said panel has affixed thereto adjacent to said specimen test a slipcover;
said slipcover having a sufficient area to cover said fluid receiving well to facilitate wet mount microscopic testing purposes.

3. The diagnostic kit according to claim 1, wherein said panel has procedure indicating indica disposed adjacent to said test site for facilitating microscopic analysis of the fluid specimen when deposited within said well.

4. The diagnostic kit according to claim 1, wherein said well has disposed therein a pH testing substance for producing a color indicative of fluid pH upon contact with the fluid specimen.

5. The diagnostic kit according to claim 3, wherein said panel include pH indication indicia disposed adjacent to said fluid receiving well for correlating a color reaction in said pH substance with fluid pH of the fluid specimen.

6. The diagnostic kit according to claim 1, wherein said panel includes at least another opening for defining another test site;
said panel being sufficiently thick to form another fluid receiving well at said another test site; and
wherein said well has a sufficient volume to confine the specimen fluid deposited therein for testing purposes.

7. The diagnostic kit according to claim 4, wherein said pH testing substance is litmus paper.

8. The diagnostic kit according to claim 1, wherein said storage container includes a slipcover well for holding a plurality of slipcovers.

9. The diagnostic kit according to claim 8, wherein said storage container includes a retainer for helping to secure the individual ones of said plurality of slipcovers within said slipcover well.

10. The diagnostic kit according to claim 8, wherein each individual one of said plurality of slipcovers has a sufficient area to cover said fluid receiving well to facilitate wet mount microscopic testing purposes.

11. The diagnostic kit according to claim 8 wherein said storage container further includes a test solution well for holding a container of reagent fluid said reagent fluid facilitating specific diagnostic analysis of the fluid specimen when mixed the fluid specimen is deposited at said test site and mixed with said reagent fluid.

12. The diagnostic kit according to claim 9 wherein said storage container further includes a test card well for holding a plurality of test result cards to record test results when using the diagnostic kit.

13. The diagnostic kit according to claim 12, wherein said storage container further includes differential diagnosis chart indicia to provide an immediate visual indication of any microscopy including syndrome identifiers and diagnostic criteria.

14. The diagnostic kit according to claim 13, wherein said storage container further includes an applicator well for holding a plurality of sterile application for use in obtaining the fluid specimen from a patient.

15. The diagnostic kit according to claim 14, wherein the diagnostic kit is a vaginal test kit for diagnosis of a plurality of different types of vaginal infections.

16. The diagnostic kit according to claim 14, wherein said storage container further includes a microscope well for holding a microscope.

17. A diagnostic kit for use in performing clinical tests on a specimen fluid, comprising:
a storage container for holding a plurality of disposable diagnostic devices, each individual one of said plurality of disposable diagnostic devices including:
a plate, said plate being sufficiently thin to permit ambient light to pass therethrough;
a panel adhered to and substantially covering said plate and having a plurality of windows disposed therein for defining a plurality of different types of diagnostic test sites and for exposing different portions of said plate;
said panel being sufficiently thick to form a fluid receiving well at individual ones of the said plurality of diagnostic test sites.

18. A method of in office testing for at least one type of vaginal infection, comprising the steps of:
providing a diagnostic kit having a plurality of disposable diagnostic devices, each individual one of said plurality of disposable diagnostic devices including:
a plate, said plate being sufficiently thin to permit ambient light to pass therethrough;
a panel adhered to and substantially covering said plate and having a plurality of windows disposed therein for defining a plurality of different types of diagnostic test site wells and for exposing different portions of said plate;
said diagnostic kit further including reagent fluids for mixing with a vaginal fluid test specimen, said reagent fluids including a saline solution and a potassium hydroxide solution;
said diagnostic kit further including a plurality of individual sterile applicators, wherein individual ones of said applicators are for obtaining the vaginal fluid test specimen; and
said diagnostic kit further including indica bearing surfaces including a color chart indicia bearing surface for providing a color gradient indicative of pH levels between a pH of about 3.0 and a pH of about 5.5.

19 A diagnostic kit for use in performing clinical tests on a specimen fluid, comprising:
at least one plate, said plate being sufficiently thin to permit ambient light to pass therethrough;
a panel adhered to and substantially covering said at least one plate and having at least one opening disposed therein for defining a specimen test site and for exposing a portion of said plate;
said panel being sufficiently thick to form a fluid receiving well at said test site, said well has a sufficient volume to confine the specimen fluid deposited therein for testing purposes; and
a slip cover removably attached to said panel adjacent to said fluid receiving well for cover said well for diagnostic analysis purposes.
